(19) United States
(12) Patent Application Publication
(10) Pub. No.: US 2011/0291658 A1
(43) Pub. Date: Dec. 1, 2011

(54) High resolution three dimensional electromagnetic survey method

(76) Inventors: Carl Joel Gustav Skogman, Jarfalla (SE); Gustav Göran Mattias Südow, Vallingby (SE); Ulf Peter Lindqvist, Segeltorp (SE); Andras Robert Juhasz, Hagersten (SE); Rune Johan Magnus Mattsson, Trangsund (SE); Lena Kristina Frenje Lund, Uppsala (SE)

(21) Appl. No.: 12/800,907

(22) Filed: May 25, 2010

(51) Int. Cl. G01V 3/17

(52) U.S. Cl. 324/337

(57) ABSTRACT

A method for electromagnetic surveying below the bottom of a body of water includes deploying a plurality of nodal recording devices in a selected pattern on the water bottom. An electromagnetic transmitter is towed in the water. At least one electromagnetic sensor streamer is concurrently towed in the water. The electromagnetic transmitter is actuated at selected times and signals detected by sensors in the nodal recording devices and in the at least one streamer are recorded.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates generally to the field of electromagnetic surveying of subsurface rock formations below bodies of water. More specifically, the invention relates to improvement of resolution of such surveys by using modified nodal sensing stations in conjunction with enhanced towed sensor streamers.

Controlled source electromagnetic (CSEM) surveying is a set of techniques for identifying electrical resistivity anomalies in subsurface rock formations. Such anomalies are known to be associated with the existence of subsurface reservoirs of hydrocarbons (oil and gas). CSEM surveys are conducted on land and in bodies of water such as lakes or the ocean (“marine surveys”) to help identify likely subsurface reservoirs in the rock formations below the water bottom.

Marine CSEM surveys are typically performed in two general methods. One method is to deploy a plurality of nodal receiver stations on the water bottom in a selected pattern. See, for example, U.S. Pat. No. 6,842,006 issued to Conti et al. for a description of an example nodal receiver station. While the receiver stations are recording, an electromagnetic (EM) transmitter antenna coupled to an electric current source is moved through the body of water. Electric current is passed through the transmitter antenna to induce an EM field in the water and in the formations below the water bottom. Responses to the induced EM fields detected by the various nodal recorders are later interpreted to estimate the presence of resistivity anomalies such as hydrocarbon reservoirs.

The other general CSEM survey method is to tow a receiver cable in the water concurrently while towing the EM transmitter antenna and periodically actuating the EM transmitter antenna. See, for example, U.S. Pat. No. 7,602,191 issued to Davidsson.

Other technology known in the art for conducting EM surveys includes ocean bottom placed cable sensor systems. See, for example, U.S. Patent Application Nos. 2008/0265895 and 2008/0265896 filed by Strack et al. Such cable systems have not yet experienced widespread commercial use due to manufacturing and maintenance costs.

Generally, EM surveying performed using a receiver node system and using a towed EM source is well suited for detection and characterization of resistive anomalies at great depths below the water bottom. However, the nature of the nodal receivers necessitates a relatively sparse placement of the receiver nodes to achieve reasonable acquisition efficiencies. A towed EM streamer system has higher spatial resolution and acquisition efficiency than a node based system, but EM streamers lack the low noise properties of the node system. Noise is principally caused by motion of the receiver streamers in the body of water. Towed EM streamer acquisition can, however, provide better lateral resolution and can enable the detection of small, shallow targets (e.g., gas pockets). On the other hand, towed EM streamers are less useful in the detection of deep targets. It should also be noted that it is preferred not to tow marine EM streamer systems near operating marine equipment and facilities such as drilling and/or production platforms.

As a practical matter, nodal acquisition and towed streamer acquisition are generally performed independently, resulting in either sparsely sampled 3D nodal data, or high-resolution, yet relatively shallow depth 2D streamer data.

There is a need for a system that combines the relatively high depth resolution of nodal EM recording systems with the spatial resolution of towed EM streamer systems.

### SUMMARY OF THE INVENTION

A method according to one aspect of the invention for electromagnetic surveying below the bottom of a body of water includes deploying a plurality of nodal recording devices in a selected pattern on the water bottom. An electromagnetic transmitter is towed in the water. At least one electromagnetic sensor streamer is concurrently towed in the water. The electromagnetic transmitter is actuated at selected times and signals detected by sensors in the nodal recording devices and in the at least one streamer are recorded.

Other aspects and advantages of the invention will be apparent from the following description and the appended claims.

### BRIEF DESCRIPTION OF THE DRAWINGS

FIG. 1 shows an example survey vessel towing an electromagnetic source antenna and an electromagnetic receiver streamer, and a plurality of receiver nodes disposed in a selected pattern on the water bottom.

FIG. 2 shows a plan view of an example survey pattern for the vessel, streamer and receiver nodes in FIG. 1 associated with a petroleum reservoir in subsurface rock formations.

### DETAILED DESCRIPTION

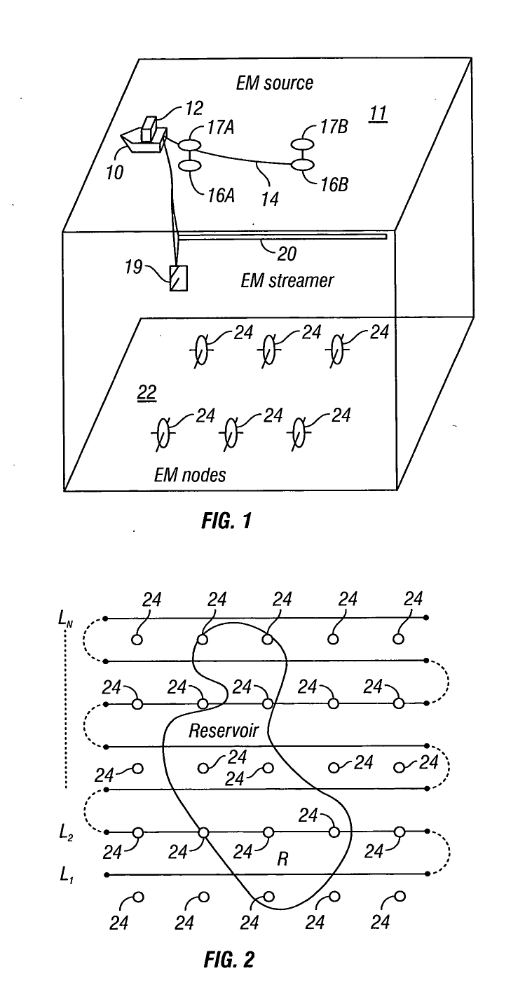

FIG. 1 shows an oblique view of an electromagnetic (EM) survey system being used in accordance with the invention. A survey vessel 10 moves along the surface of a body of water 11 such as a lake or the ocean. The vessel tows an EM transmitter, which in the present example can be a longitudinal electric dipole consisting of two spaced apart electrodes 16A, 16B disposed on an insulated electrical cable 14. The electrodes 16A, 16B may be suspended at a selected depth in the water 11 using floats 17A, 17B or other buoyancy control devices. The vessel 10 may include equipment thereon shown generally at 12 and referred to for convenience as a recording system. The recording system 12 may include devices (none shown separately for clarity) for navigating the vessel 10, for passing electric current across the transmitter electrodes 16A, 16B at selected times, for detecting and recording signals detected by EM receivers in a sensor streamer 20 and for retrieving and processing detected EM signals recorded at a plurality of receiver nodes 24 disposed on the water bottom 22 in a selected pattern. The EM receiver streamer 20 may be moved at a greater depth in the water 11 than the transmitter cable 14 by using a depressor 19 at the forward end of the streamer 20. It should be clearly understood that the example EM transmitter shown in FIG. 1, which is a horizontal longitudinal electric dipole is not the only type of EM transmitter that can be used in accordance with the invention. Other non-limiting examples of EM transmitters include wire loops or coils energized with electric current (magnetic dipoles) oriented to have magnetic dipole moment along any selected direction as well as electric dipoles oriented along any other selected direction than the one shown in FIG. 1. The nature of the electric current passed through the EM transmitter is also not a limit on the scope of the present invention. The current may be alternating current having one or more individual discrete frequencies to perform frequency domain CSEM surveying. The current may also be switched direct current, for example switched on, switched off, inverted polarity or a combination of switching events such as a pseudorandom binary sequence, any of which may be used to perform time domain CSEM surveying.

Referring to FIG. 2, in conducting a EM survey using the system shown in FIG. 1, the EM receiver nodes 24 may be disposed in a selected pattern such as a grid that includes what may be a subsurface reservoir R, identified, for example by surface conducted seismic surveys. During EM surveying, the transmitter (16A, 16B in FIG. 1) may be actuated using a selected current waveform, which may be continuous sine wave having one or more discrete frequencies, a sweep of frequencies such as used in a sonar or radar “chirp” or switched direct current as described above, such as switching on, switching off, reversing polarity or a switching sequence such as a pseudorandom binary sequence. Signals detected by sensors in the receiver nodes 24 may be recorded locally at each node, while signals from sensors on the streamer (20 in FIG. 1) may be conducted to the recording system (12 in FIG. 1) for recording. The vessel (10 in FIG. 1) may be made to traverse several parallel lines L₁-L_{N} along the water surface to obtain streamer and node signals over the area believed to cover the reservoir R. The exact pattern traversed by the vessel (10 in FIG. 1) is only presented as an example and is not intended to limit the scope of the invention.

High resolution, three-dimensional EM survey results, according to embodiments of the invention, may utilize several possible modifications to typical techniques used in EM surveying.

The node spacing can be made more sparse, thereby saving on materials costs and improving operational efficiency. As would be understood by one of ordinary skill in the art with the benefit of this disclosure, data gathered by the nodal part of the EM survey system may focus on deep target detection. Consequently, the nodal deployment can be done on a more sparse grid (typically with an about 3 km pitch) than is ordinarily performed with nodes used on a standalone basis.

The streamers can be made shorter than typical streamers (e.g., about 1-2 km instead of the more common 5-6 km), and the streamer array may benefit from a larger lateral spread than traditionally utilized. Shorter streamers may be less expensive to produce and maintain, and operations with shorter streamers may be more efficient. Data gathered by the streamer part of the EM survey system may focus on improved lateral coverage. The long offsets achieved by long streamers will not be required as these primarily are used for deep target detection, which in the present example is performed by the nodal part of the EM survey system.

To process the signals acquired by both the nodes and the streamers, a joint inversion may be performed. Such processing may provide enhanced results in overburden characterization from the streamer data, along with an enhanced depth sensitivity due to the nodal data. A typical application of such combined nodal/streamer acquisition and processing technique would be areas with a complicated geology where a high sensitivity for both shallow and deep structures is essential for correct processing (salt domes, faults etc.). The processing may be performed on a computer (not shown separately) in the recording system (12 in FIG. 1) or any other suitably programmed computer. A suitable example method for inversion processing EM signals to obtain information about subsurface structures is described in U.S. Pat. No. 6,914,433 issued to Wright et al. Other inversion techniques are known in the art.

In a particular implementation of the processing, magnetotelluric (MT) signal, which may be detected by the sensors on the streamer (20 in FIG. 1), thus creating a source of noise in the detected electric field, may be corrected by using measurements of the MT signal made by detectors (not shown separately) in the receiver nodes (24 in FIG. 1). It will be appreciated by those skilled in the art that MT signals may be detected and recorded by the receiver nodes (24 in FIG. 1) during times when the EM transmitter is not active.

A combined receiver node and towed EM streamer method and system as described herein can identify both shallow and deep targets while increasing overall acquisition efficiency, because the EM transmitter only needs to be moved through the survey area once for both streamer data acquisition and receiver node data acquisition.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for electromagnetic surveying below the bottom of a body of water, comprising:
deploying a plurality of nodal recording devices in a selected pattern on the water bottom;
towing an electromagnetic transmitter in the water;
concurrently towing at least one electromagnetic sensor streamer in the water;
actuating the electromagnetic transmitter at selected times; and
recording signals detected by sensors in the nodal recording devices and in the at least one streamer.

2. The method of claim 1 wherein a spacing between adjacent nodal recording devices is at least about 3 kilometers.

3. The method of claim 1 wherein a length of the at least one streamer is between about 1 to 2 kilometers.

4. The method of claim 1 further comprising:
concurrently towing a plurality of laterally spaced apart electromagnetic sensor streamers; and
recording signals from sensors thereon in response to actuations of the electromagnetic transmitter.

5. The method of claim 1 wherein the electromagnetic transmitter is a horizontal electric dipole.

6. The method of claim 1 further comprising inverting the recorded signals from the at least one streamer and from the nodal recording devices to obtain images of rock formations below the water bottom.

7. The method of claim 1 further comprising jointly inverting recorded signals from both the sensors in the nodal recording devices and in the at least one streamer.

8. The method of claim 1 further comprising correcting signals detected by the sensor streamer in response to the transmitter for magnetotelluric effects using magnetotelluric signals detected by the nodal recording devices.
